(19) United States
(12) Patent Application Publication
(10) Pub. No.: US 2026/0048736 A1
(43) Pub. Date: Feb. 19, 2026

(54) VEHICLE AND A CONTROL METHOD THEREOF

(71) Applicants: HYUNDAI MOTOR COMPANY, Seoul (KR); KIA CORPORATION, Seoul (KR)

(72) Inventors: Sang Min Lee, Hwaseong-si (KR); Dae Seok Jeon, Hwaseong-si (KR); Tae Geun An, Hwaseong-si (KR); Joon Ho Lee, Hwaseong-si (KR); Eung Seo Kim, Hwaseong-si (KR); Yong Seok Kwon, Hwaseong-si (KR)

(73) Assignees: HYUNDAI MOTOR COMPANY, Seoul (KR); KIA CORPORATION, Seoul (KR)

(21) Appl. No.: 19/261,307

(22) Filed: Jul. 7, 2025

(30) Foreign Application Priority Data
Aug. 14, 2024 (KR) 10-2024-0109162

(51) Int. Cl. B60W 30/09; B60W 10/18; B60W 60/00; G06V 20/58

(52) U.S. Cl. CPC B60W 30/09; B60W 10/18; B60W 60/0015; G06V 20/58; B60W 2420/403; B60W 2540/18; B60W 2552/30; B60W 2552/53; B60W 2554/4041; B60W 2554/802; B60W 2555/20; G06V 2201/07

(57) ABSTRACT

An autonomous driving vehicle includes a processor. The processor receives at least one sensor information from a plurality of sensors mounted to a host vehicle; recognizes a target object disposed in front of the driving host vehicle based on the received sensor information; compares and analyzes a driving environment condition of a current driving road of the host vehicle with the target object; calculates a desensitization control point corresponding to a compared and analyzed result; and controls a braking state of the host vehicle to be varied based on the calculated desensitization control point.

### CROSS-REFERENCE TO RELATED APPLICATIONS

The present application claims the benefit of and priority to Korean Patent Application No. 10-2024-0109162, filed on Aug. 14, 2024, the entire contents of which are incorporated herein by reference.

### TECHNICAL FIELD

The present disclosure relates to a vehicle and a control method thereof. More particularly, the present disclosure relates to a vehicle capable of stably operating an advanced driver assist system (ADAS) in an unstable road surface state and relates to a control method thereof.

### BACKGROUND

In recent years, development of an advanced driver assist system (ADAS) for securing safety of a driver and providing driving convenience is accelerated.

The ADAS is a system for assisting a vehicle to drive safely and conveniently by performing a vehicle control, such as steering, braking, acceleration, and deceleration of a vehicle, by using sensor data recognized by sensors, such as a camera and a radar.

However, the ADAS has a limitation of generating a sensitive warning in a transition section in which a straight road is changed to a curved road or a curved road is changed to a straight road by a transverse motion of the vehicle during turning in case of a common stationary obstacle (e.g., a reflector in a guardrail) in a high-curvature road condition.

The subject matter described in this background section is intended to promote an understanding of the background of the disclosure and thus may include subject matter that is not already known to those of ordinary skill in the art.

### SUMMARY

The present disclosure provides a vehicle and a control method thereof for controlling control sensitivity in consideration of a behavior of the vehicle and environmental factors to prevent unnecessary sensitive warnings in a high-curvature road condition.

Technical objects to be solved by the present disclosure are not limited to the aforementioned technical objects, and unmentioned technical objects should be clearly understood by those having ordinary skill in the art to which the present disclosure belongs.

An embodiment of the present disclosure provides an autonomous driving vehicle including a processor configured to execute computer-readable instructions; and a memory configured to store the computer-readable instructions. The processor is configured, by executing the computer-readable instructions, to receive sensor information from at least one of a plurality of sensors mounted to the vehicle. The processor is further configured, by executing the computer-readable instructions, to recognize a target object in front of the vehicle based on the received sensor information. The processor is further configured, by executing the computer-readable instructions, to determine a desensitization control point based on the target object and a driving environment condition of a current driving road of the vehicle. The processor is further configured, by executing the computer-readable instructions, to control braking of the vehicle based on the desensitization control point.

In an embodiment, the driving environment condition may include a first driving environment condition associated with a driving state of the vehicle traveling on a curved road. The driving state is determined based on information of the vehicle sensed by at least one sensor of the plurality of sensors.

In an embodiment, the driving environment condition may include a second driving environment condition associated with a position of the target object on a curved road based on lane information of the current driving road.

In an embodiment, the driving environment condition may include a third driving environment condition associated with illumination environment information.

In an embodiment, the processor may be further configured, by executing the computer-readable instructions, to determine at least one index of a first index value (V1), a second index value (V2), or a third index value (V3) according to the first driving environment condition, and determine the desensitization control point based on the at least one index.

In an embodiment, the processor may be further configured, by executing the computer-readable instructions, to determine a first predetermined value as the first index value (V1) based on a variation rate of a steering angle of the vehicle being deviated from a predetermined turning range.

In an embodiment, the processor may be further configured, by executing the computer-readable instructions, to determine a second predetermined value as the second index value (V2) based on a radius of a traveling path of the vehicle being within a predetermined high-curvature turning range.

In an embodiment, the processor may be further configured, by executing the computer-readable instructions, to determine a third predetermined value as the third index value (V3) based on an expected position of the vehicle after a predetermined time is within a predetermined rage.

In an embodiment, the processor may be further configured, by executing the computer-readable instructions, to determine at least one index of a fourth index value (L1) or a fifth index value (L2) according to the second driving environment condition. The processor may be further configured, by executing the computer-readable instructions, to determine the desensitization control point based on the at least one index.

In an embodiment, the processor may be further configured, by executing the computer-readable instructions, to determine a fourth predetermined value as the fourth index value (L1) based on a longitudinal position (Xm) of the target object with respect to the vehicle is within a predetermined range

In an embodiment, the processor may be further configured, by executing the computer-readable instructions, to determine a fifth predetermined value as the fifth index value (L2) based on a transverse position of the target object is deviated from a lane of the vehicle.

In an embodiment, the processor may be further configured, by executing the computer-readable instructions, to determine a sixth predetermined value as a sixth index value (E) based on the third driving environment condition being determined as nighttime.

In an embodiment of the present disclosure, a method for controlling a vehicle includes receiving, by a processor, sensor information from at least one of a plurality of sensors mounted to the vehicle. The method further includes recognizing, by the processor, a target object in front of the vehicle based on the received sensor information. The method further includes determining, by the processor, a desensitization control point based on the target object and a driving environment condition of a current driving road of the vehicle. The method further includes controlling, by the processor, a braking of the vehicle based on the desensitization control point.

In an embodiment of the method, the driving environment condition may include a first driving environment condition associated with a driving state of the vehicle traveling on a curved road. The driving state is determined based on information of the vehicle sensed by at least one sensor of the plurality of sensors.

In an embodiment of the method, the driving environment condition may comprise a second driving environment condition associated with a position of the target object on a curved road based on lane information of the current driving road.

In an embodiment of the method, the driving environment condition may comprise a third driving environment condition associated with illumination environment information.

In an embodiment of the method, determining the desensitization control point may include determining at least one index of a first index value (V1), a second index value (V2), or a third index value (V3) according to the first driving environment condition. Determining the desensitization control point may further include determining the desensitization control point based on the at least one index.

In an embodiment of the method, determining the at least one index of the first index value (V1), the second index value (V2), or the third index value (V3) may include determining a first predetermined value as the first index value (V1) based on a variation rate of a steering angle of the vehicle being deviated from a predetermined turning range

In an embodiment of the method, determining the at least one index of the first index value (V1), the second index value (V2), or the third index value (V3) may include determining a second predetermined value as the second index value (V2) based on a radius of a traveling path of the vehicle being within a predetermined high-curvature turning range.

In an embodiment of the method, determining the at least one index of the first index value (V1), the second index value (V2), or the third index value (V3) may include determining a third predetermined value as the third index value (V3) based on an expected position of the vehicle after a predetermined time is within a predetermined rage.

In an embodiment of the method, under control of the processor, the at least one of the fourth index value L1 and the fifth index value L2 may be calculated according to the second driving environment condition. A driving state may be determined based on the calculated index value. It may be determined that a lane curvature of a longitudinal position Xm of the target object is within a predetermined high-curvature turning range when the fourth index value L1 is equal to 1.

In an embodiment of the method, under control of the processor, it may be determined that a transverse position of the target object is deviated from a lane when the fifth index value L2 is equal to 1.

### BRIEF DESCRIPTION OF THE DRAWINGS

FIG. 1 is a block diagram for explaining an autonomous driving vehicle according to an embodiment of the present disclosure.

FIG. 2 is a flowchart for explaining a method for controlling an autonomous driving vehicle according to an embodiment of the present disclosure.

FIG. 3 is a view for explaining a fifth index value according to an embodiment of the present disclosure.

FIGS. 4-8 are views for explaining a variation of a driving control point or braking control of a host vehicle according to an embodiment of the present disclosure.

### DETAILED DESCRIPTION OF ILLUSTRATIVE EMBODIMENTS

Hereinafter, embodiments of the present disclosure are described in detail with reference to the accompanying drawings. Thus, the technical idea of the present disclosure may easily be carried out by a person with ordinary skill in the art to which the present disclosure pertains. The present disclosure may, however, be embodied in different forms and should not be construed as limited to the embodiments set forth herein. In the following description of the present disclosure, a detailed description of known functions and configurations incorporated herein has been omitted to avoid making the subject matter of the present disclosure unclear. Like reference numerals are used for referring to the same or similar elements in the description and drawings.

Furthermore, when it is described that one element comprises (or includes or has) some elements, it should be understood that the element may comprise (or include or has) only those elements, or the element may comprise (or include or have) other elements as well as those elements if there is no specific limitation. Like reference numerals refer to like elements throughout the present disclosure.

Also, the term “Unit” or “Control Unit,” as included in names such as vehicle control unit (VCU), is widely used to refer to controller that control specific functions of a vehicle and does not imply a generic function unit. Also, the devices denoted by the names may include a communication device that communicates with another controller or sensor to control the corresponding function, a computer-readable recording medium that stores an operation system, a logic command, and input/output information, and at least one processor that performs determinations, decisions, and calculations required for function control.

When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

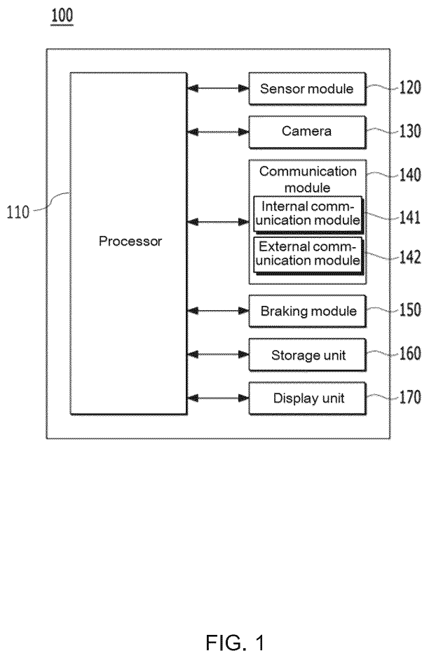

FIG. 1 is a block diagram for explaining an autonomous driving vehicle according to an embodiment of the present disclosure.

Referring to FIG. 1, an autonomous driving vehicle 100 according to an embodiment of the present disclosure may include a processor 110, a sensor module 120, a camera 130, a communication module 140, a braking module 150, a storage unit 160, and a display unit 170.

The processor 110 may be disposed in the autonomous driving vehicle 100 and electrically connected to at least one component or module mounted to the autonomous driving vehicle 100 to control the entire autonomous driving vehicle 100 while exchanging all sorts of data or signals with the at least one electrically connected component or module through wired or wireless communication.

For example, components of the autonomous driving vehicle 100 may exchange signals or data through an internal communication module 141 that is a communication module 140 of the autonomous driving vehicle 100 under control of the processor 110. For example, the internal communication module 141 of the autonomous driving vehicle 100 may include at least one communication protocol (e.g., CAN, LIN, FlexRay, MOST, and Ethernet).

The processor 110 may perform control of the autonomous driving vehicle 100 through controlling other components mounted to the autonomous driving vehicle 100. For example, the processor 110 may perform at least one function of EMS (Engine Management System), ESC (Electronic Stability Control), ESP (Electronic Stability Program), VDC (Vehicle Dynamic Control), LKAS (Lane Keeping Assistance System), SCC (Smart Cruise Control), ACC (Adaptive Cruise Control), AEB (Autonomous Emergency Braking), FCA (Forward Collision-Avoidance Assist), HDA (Highway Driving Assist), HDP (Highway Driving Pilot), LDW (Lane Departure Warning), DAW (Driver Awareness Warning), DSW (Driver State Warning), or TCS (Traction Control System). The above-described functions may be referred to as an advanced driver assist system (ADAS).

The processor 110 may receive at least one sensor information from the sensor module 120 mounted to the autonomous driving vehicle 100. The processor 110 may recognize a target object disposed in front of the autonomous driving vehicle 100 while the autonomous driving vehicle 100 driving based on the received sensor information. The autonomous driving vehicle 100 may also be referred to as a host vehicle. Hereinafter, the autonomous driving vehicle 100 is referred to as the host vehicle.

Here, the target object may include a general stationary obstacle or a reflector in a guardrail in a driving road or out of the driving road. However, the embodiment of the present disclosure is not limited thereto.

The processor 110 may compare and analyze the recognized target object with a driving environment condition of a current driving road on which the host vehicle 100 is driving and may calculate a desensitization control point corresponding to a result of comparison and analysis.

The processor 110 may control a braking control state of the host vehicle to be varied based on the calculated desensitization control point.

Here, the braking control state of the host vehicle 100 may include a control point, a control intensity, and a control magnitude. This is described below in detail.

The sensor module 120 may be mounted to the host vehicle 100 and may sense at least one object disposed around the host vehicle 100. Here, the object may include another vehicle (e.g., a vehicle disposed at the front, behind, left, or right), a pedestrian, an obstacle, a transportation unit (e.g., a bicycle, an electric scooter, an electric bicycle, a motorcycle, and an electric unicycle), and a target object.

For example, the sensor module 120 may use at least one sensor to precisely sense or recognize information of the object, such as a position of the object, a distance from the host vehicle 100 to the object, a direction in which the object is spaced apart from the host vehicle 100, a movement direction of the object, or a speed of the object.

For example, under control of the processor 110, the sensor module 120 may accurately sense a change in a position relationship between the host vehicle 100 and the object using at least one sensor. Here, the at least one sensors may include a radar sensor, a light detection and ranging (LiDAR) sensor, an infrared sensor, an ultrasonic sensor, and a laser sensor. For example, a laser sensor may accurately sense or recognize a position relationship between the autonomous driving vehicle 100 and the object by using methods such as time-of-flight (TOF) or/and phase-shift according to laser signal modulation methods.

For example, under control of the processor 110, the sensor module 120 may sense or recognize a target object disposed in front of the host vehicle 100, an object driving ahead of the host vehicle 100, a lane of a driving road, and a surrounding environment of the driving road.

The sensor module 120 may detect an object disposed in at least one area among a front, rear, left, or right area of the host vehicle 100 under the control of the processor 110. The at least one sensor may be mounted at various positions of the host vehicle 100. For example, the at least one sensor may be mounted at least one position among the front, rear, left, right, or roof of the autonomous driving vehicle 100.

Also, when a plurality of objects is provided, the sensor module 120 may sense a plurality of objects simultaneously. However, the embodiment of the present disclosure is not limited thereto. For example, the sensor module 120, under the control of the processor 110, may sense the objects and set a target object among the plurality of objects in consideration of a speed of the object, a distance between the object and the host vehicle 100, and a size of the object. The sensor module 120, under the control of the processor 110, may sense the set target object firstly over other objects and track the object.

The above-described at least one sensor may include heading sensors, yaw sensors, gyro sensors, vehicle forward/reverse sensors, wheel sensors, vehicle speed sensors, body tilt detection sensors, battery sensors, fuel sensors, tire sensors, steering sensors based on handle rotation, vehicle interior temperature sensors, vehicle interior humidity sensors, or door sensors.

The camera 130 may collect images of surroundings of the host vehicle 100 or images of the inside of the host vehicle 100. At least one cameras 130 may be mounted to the host vehicle 100 to collect front-view images, rear-view images, and side-view images of the host vehicle 100.

The camera 130 may provide collected images to the processor 110. For example, the processor 110 may analyze the images collected through the camera 130, may process still images or videos, and may extract necessary image information from the processed still images or videos.

For example, the camera 130 may include a charge coupled device (CCD) image sensor or a complementary metal oxide semiconductor (CMOS) image sensor. The camera 130 may also include a three-dimension space recognition sensor such as an RGB-D sensor (KINECT), a structured light sensor (TOF), or a stereo camera.

The communication module 140 may communicate with at least one base stations, external devices, or other vehicles. Here, the other vehicles may include a front vehicle, a rear vehicle, and side vehicles based on the host vehicle 100 while driving.

The communication module 140, under the control of the processor 110, may receive driving information from the other vehicles. The driving information may include position, speed, acceleration, direction, predicted path, path history, or forward collision-avoidance assist (FCA) signals of the other vehicles.

For example, the communication module 140 may include an internal communication module 141 and an external communication module 142.

The internal communication module 141 may transmit or receive information using various communication protocols existing in the host vehicle 100.

Here, the communication protocols may include at least one of controller area network (CAN), CAN with flexible data rate (CAN FD), Ethernet, local interconnect network (LIN), or FlexRay. The communication protocol may include other protocols for communication between various devices mounted to the host vehicle 100.

The external communication module 142 may perform vehicle-to-vehicle (V2V) communication with other vehicles or vehicle-to-infrastructure (V2I) communication with infrastructure systems.

Here, the infrastructure system may be a roadside unit or server that periodically transmits traffic information in conjunction with a transportation information system (TIS) or an intelligent transport system (ITS).

However, the embodiment of the present disclosure is not limited thereto. For example, the external communication module 142 may perform vehicle-to-everything (V2X) communication. The external communication module 142 may use various communication methods, such as VANET (Vehicular Ad Hoc Network (VANET), WAVE (Wireless Access in Vehicular Environments), DSRC (Dedicated Short Range Communication), CALM (Communication Access in Land Mobile), V2N (Vehicle-to-Network), WLAN (Wireless LAN) communication, Wi-Fi (Wireless-Fidelity) communication, WiBro (Wireless Broadband) communication, LTE (Long Term Evolution) communication, LTE-A (Long Term Evolution-Advanced) communication, 5G communication, 6G communication, UWB (Ultra Wideband) communication, ZigBee communication, and NFC (Near Field Communication) communication.

The communication module 140 may include at least one of a transmission antenna, a reception antenna, a radio frequency (RF) circuit capable of realizing various communication protocols, or RF components.

Also, the communication module 140 may perform communication with a smart device of a passenger.

The braking module 150, under the control of the processor 110, may brake the host vehicle 100 while the host vehicle is driving. Under the control of the processor 110, the braking module 150 may suddenly or gradually brake the host vehicle 110 in response to a provided braking signal. Here, the braking signal may include information of a time-to-collision (TTC) signal (hereinafter, referred to as a TTC signal) with a front vehicle or rear vehicle relative to the host vehicle 100.

The braking module 150, under the control of the processor 110, may gradually or suddenly reduce a speed of the host vehicle 100 based on a braking signal.

For example, the braking module 150 may include a plurality of wheel brakes FL, FR, RL, and RR.

For example, the plurality of wheel brakes FL, FR, RL, and RR may include a first wheel brake FL that brakes a front left wheel of the host vehicle 100, a second wheel brake FR that brakes a front right wheel of the host vehicle 100, a third wheel brake RL that brakes a rear left wheel of the host vehicle 100, and a fourth wheel brake RR that brakes a rear right wheel of the host vehicle 100.

The plurality of wheel brakes may be installed on respective wheels of the host vehicle 100. For example, each of the plurality wheel brakes FL, FR, RL, and RR may be independently controlled to generate braking force for each wheel.

The storage unit 160 may be mounted into or separated from the host vehicle 100. The storage unit 160 may store programs and information required for controlling the advanced driver assist system (ADAS).

The storage unit 160 may store information sensed by the sensing module 120, image data collected by the camera 130, information generated by the processor 110, or information received by the communication module 140. However, the embodiment of the present disclosure is not limited thereto. Here, the storage unit 160 may be referred to as a memory.

The display unit 170 may be mounted inside the host vehicle 100. The display unit 170, under the control of the processor 110, may display a driving assist system related to the host vehicle 100. For example, the display unit 170 may include a cluster.

As described above, the host vehicle 100 according to embodiments of the present disclosure may, under the control of the processor 110, determine turning a highly curved road or determine inner/outer positions of lanes and paths with high curvature for general stationary obstacles to control appropriately control sensitivity of the host vehicle 100 in various situations by varying a braking state of the host vehicle 100 in correspondence to at least one braking range.

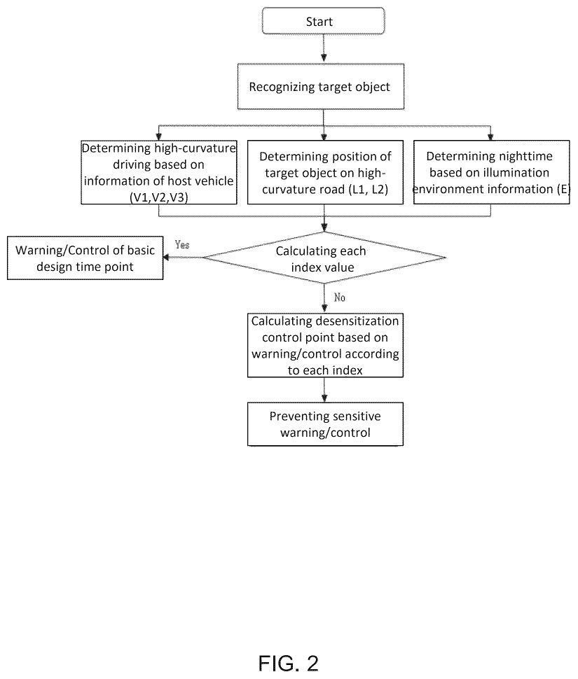

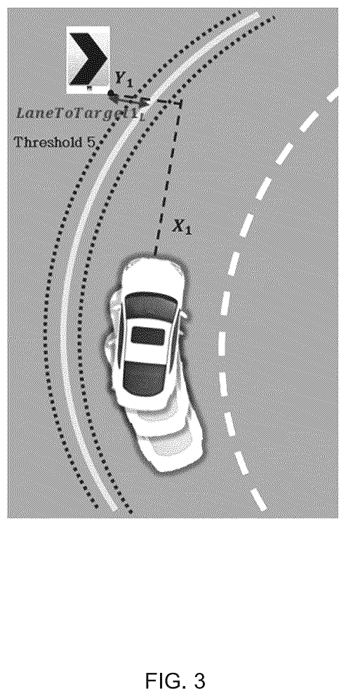

FIG. 2 is a flowchart for explaining a method for controlling an autonomous driving vehicle according to an embodiment of the present disclosure. FIG. 3 is a view for explaining a fifth index value according to an embodiment of the present disclosure.

Referring to FIG. 2, the method for controlling the host vehicle according to embodiments of the present disclosure is described below.

The host vehicle 100, under the control of the processor 110, may receive at least one piece of sensor information from a plurality of sensor modules 120 mounted to the host vehicle 100 and may recognize a target object disposed in front of the host vehicle 100 while the host vehicle 100 is driving based on the sensor information. Here, the target object may be referred to as a front control object.

The host vehicle 100, under the control of the processor 110, may compare and analyze the recognized target object with a driving environment condition of a current driving road on which the host vehicle 100 is driving.

The host vehicle 100, under the control of the processor 110, may identify the target object that is the front control object and may compare and analyze the target object with the driving environment condition of the current driving road on which the host vehicle 100 is driving.

The driving environment condition of the current driving road may include at least one condition. For example, the driving environment condition of the current driving road may include a first driving environment condition to a third driving environment condition.

The first driving environment condition may determine the driving state for a high-curvature driving road based on information of the host vehicle 100.

The second driving environment condition may determine the target object in a high-curvature driving road or a position outside the driving road based on lane information of the driving road.

The third driving environment condition may determine whether it is nighttime based on illumination environment information.

The host vehicle 100, under the control of the processor 110, may calculate a first index value V1 according to the first driving environment condition and may determine a driving state based on the calculated first index value V1.

For example, the processor 110 may determine that, when the first index value V1 is 1, a variation rate of a steering angle of the host vehicle 100 is deviated from a normal turning range.

For example, the processor 110 may determine that, when the first index value V1 is equal to 1, a steering angle sensor (SAS) rate is equal to or greater than a predetermined first reference value Threshold 1.

As described above, the host vehicle 100, under the control of the processor 110, may provide a warning or perform partial braking when the first index value V1 is calculated as 1 to prevent sensitive control due to temporary abnormal transverse movement while turning the high-curvature driving road.

Here, a desensitization rate of the first index value V1 index may be expressed as “a.”

The host vehicle 100, under the control of the processor 110, may calculate a second index value V2 according to the first driving environment condition and determine a driving state based on the calculated second index value V2.

For example, the processor 110 may determine that, when the second index value V2 is equal to 1, a radius of the host vehicle 100 is within an extreme high-curvature turning range. Here, when the second index value V2 is equal to 1, the curvature may correspond to a U-turn level of curvature.

For example, the processor 110 may determine that, when the second index value V2 is equal to 1, an absolute value (|Radius|) of the radius of the host vehicle 100 is equal to or less than a second threshold value Threshold 2.

As described above, the host vehicle 100, under the control of the processor 110, may control the vehicle with at least one of a warning, partial braking, and full braking to prevent sensitive control in a situation of turning an extremely high-curvature driving road when the second index value V2 is calculated as 1.

Here, a desensitization rate of the second index value V2 index may be expressed as “b.”

The host vehicle 100, under the control of the processor 110, may calculate a third index value V3 according to the first driving environment condition and may determine a driving state based on the calculated third index value V3.

For example, the processor 110 may determine that, when the third index value V3 is equal to 1, an expected position of the host vehicle after one second is within the turning range.

The processor 110 may determine that, when the third index value V3 is equal to 1, the expected position (|SvPosYfls|) of the host vehicle may be equal to or greater than the third threshold value Threshold 3.

As described above, the host vehicle 100, under the control of the processor 110, may determine that, when the third index value V3 is calculated as 1, the position is in a stabilization section before transitioning from the high-curvature driving road to straight-line driving. In other words, the host vehicle 100, under the control of the processor 110, may provide a warning during the stabilization section to prevent the sensitive warning.

Here, the desensitization rate of the third index value V3 may be expressed as “c.”

When comparing the desensitization rates of the first index value V1 index, second index value V2 index, and third index value V3 index, the desensitization rates may be expressed as a=>b.

The host vehicle 100, under the control of the processor 110, may calculate a fourth index value L1 according to the second driving environment condition and may determine a position of the target object based on the calculated fourth index value L1.

For example, the processor 100 may determine that, when the fourth index value L1 is equal to 1, a lane curvature of a longitudinal position of the target object is within a high-curvature turning range.

For example, when the fourth index value L1 is equal to 1, the processor 110 may calculate a product of the longitudinal position Xm of the target object and the lane curvature rate, may add this to the lane curvature, and may determine that the calculated value is equal to or greater than a predetermined fourth threshold value Threshold 4.

As described above, the host vehicle 100, under the control of the processor 110, may provide a warning to prevent sensitive warning related to vertical movement before entering turning after driving straight when the fourth index value L1 is calculated as 1.

Here, a desensitization rate of the fourth index value L1 index may be expressed as “d.”

The host vehicle 100, under the control of the processor 110, may calculate a fifth index value L2 according to the second driving environment condition and may determine a position of the target object based on the calculated fifth index value L2.

For example, the processor 110 may determine that, when the fifth index value L2 is equal to 1, a transverse position of the target object is outside a lane.

Referring to FIG. 3, e.g., the processor 110 may determine that, when the fifth index value L2 is equal to 1, LaneToTarget1L may be equal to or greater than a predetermined fifth threshold value Threshold 5. This may be expressed as Equation 1 as follows.

LaneToTarget1L=Y1−d1=Y1−(aLX13+bLX12+CLX1+dL) [Equation 1]

Here, d1 may represent a left lane equation.

As described above, the host vehicle 100, under the control of the processor 110, may control the vehicle with at least one of the warning, partial braking, or full braking to adjust warning and may control sensitivity based on presence of the target object in the lane when the fifth index value is calculated as 1.

Here, a desensitization rate of the fifth index value L2 index may be expressed as “e.”

When the desensitization rates of the fourth index value L1 index and the fifth index value L2 index are compared, the desensitization rates may be expressed as d≥e.

The host vehicle 100, under the control of the processor 110, may calculate a sixth index value E according to the third driving environment condition and may determine whether it is nighttime based on the calculated sixth index value E.

For example, the processor 110 may determine that, when the sixth index value E is equal to 1, the illumination environment information is nighttime.

For example, the processor 110 may determine that, when the sixth index value E is equal to 1, the illumination environment information determined by a front camera may determine nighttime.

As described above, the host vehicle 100, under the control of the processor 110, may provide a warning to avoid a wrong decision caused by warning desensitization due to incorrect lane information detection during nighttime conditions when the sixth index value E is calculated as 1.

The host vehicle 100, under the control of the processor 110, may calculate a desensitization control point corresponding to the compared and analyzed results.

For example, the host vehicle 100, under the control of the processor 110, may calculate the desensitization control point based on the above-described first index value V1 to sixth index value E. The host vehicle 100, under the control of the processor 110, may express a warning desensitization rate, a partial braking desensitization rate, and a full braking desensitization rate based on the calculated desensitization control point using Equations 2 to 5 as follows.

Desensitization point=warning and control original point*(1−desensitization rate)[Equation2]

Warning desensitization rate=1−{(1−V1*a)*(1−V2*b)*(1−V3*c)*(1−L1*d)*(1−L2*e)*(1−E*f)} [Equation 3]

Partial braking desensitization rate=1−{(1−V1*a)*(1−V2*b)*(1−L2*e)} [Equation 4]

Full braking desensitization rate=1−{(1−V2*b)*(1−L2*e)} [Equation 5]

In the above-described Equations 3 to 5, a to f represent the desensitization rates defined for each index, and the desensitization rates may satisfy 0<a to f≤0.3.

The above-described host vehicle 100, may control a braking state based on the calculated desensitization control point under the control of the processor.

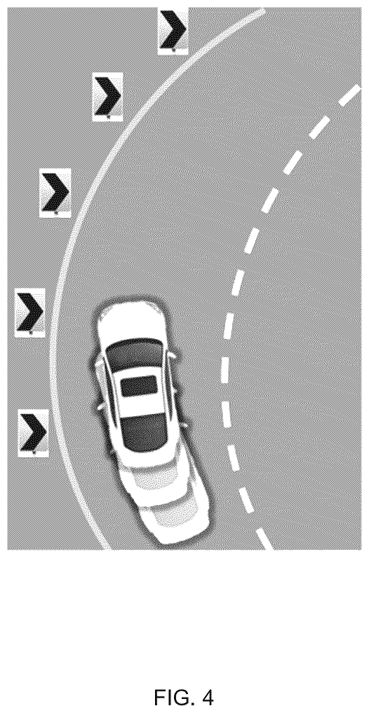

FIGS. 4-8 are views for explaining how to change a driving control point or braking control point of the host vehicle according to an embodiment of the present disclosure.

According to an embodiment of the present disclosure, FIG. 4 illustrates a case in which the host vehicle 100, under the control of the processor 110, is in a condition of preventing sensitive warnings and control, in a nighttime, in a high-curvature situation, and in a situation in which the target object is outside the lane. This represents a desensitized state without sensitive warnings or sensitive control.

Here, the first index value V1 may be 1, the second index value V2 may be 0, the third index value V3 may be 1, the fourth index value L1 may be 1, the fifth index value L2 may be 1, and the sixth index value E may be 1. When the above values are applied to Equations 3 to 5 under the control of the processor 110, the equation may be expressed as follows.

Warning desensitization rate=1−{(1−a)*(1−c)*(1−d)*(1−e)*(1−f)}

Partial braking desensitization rate=1−{(1−a)*(1−e)}

Full braking desensitization rate=1−(1−e)=e

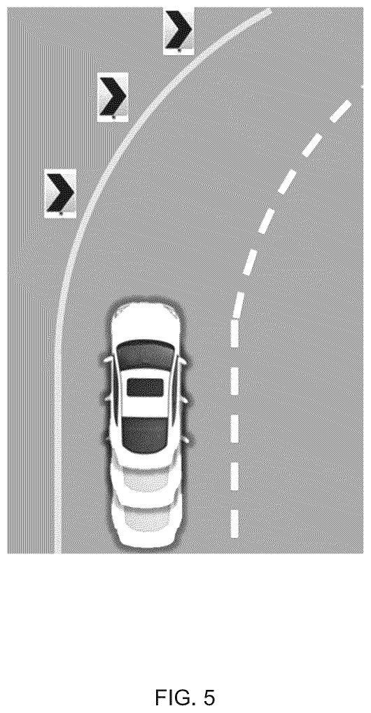

According to an embodiment of the present disclosure, FIG. 5 illustrates a case in which the host vehicle 100, under the control of the processor 110, is in a situation of preventing sensitive warnings and control, in a situation of a transition from straight driving to entering a high-curvature section, and in a situation in which the target object is outside the lane. This represents a desensitized state without sensitive warnings or sensitive control.

Here, the first index value V1 may be 0, the second index value V2 may be 0, the third index value V3 may be 0, the fourth index value L1 may be 1, the fifth index value L2 may be 1, and the sixth index value E may be 0. When the above values are applied to Equations 3 to 5 under the control of the processor 110, the equation may be expressed as follows.

Warning desensitization rate=1−{(1−d)*(1−e)}

Partial braking desensitization rate=1−(1−e)=e

Full braking desensitization rate=1−(1−e)=e

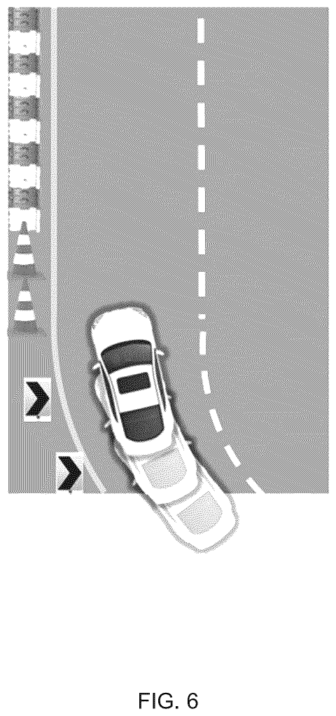

According to an embodiment of the present disclosure, FIG. 6 illustrates a case which the host vehicle 100, under the control of the processor 110, is in a situation of preventing sensitive warnings and control, in a daytime situation, in a situation just before transitioning to straight driving after turning, and in a situation in which target object is outside the lane. This represents a desensitized state without sensitive warnings or sensitive control.

Here, the first index value V1 may be 0, the second index value V2 may be 0, the third index value V3 may be 1, the fourth index value L1 may be 0, the fifth index value L2 may be 1, and the sixth index value E may be 0. When the above values are applied to Equations 3 to 5 under the control of the processor 110, the equation may be expressed as follows.

Warning desensitization rate=1−{(1−c)*(1−e)}

Partial braking desensitization rate=1−(1−e)=e

Full braking desensitization rate=1−(1−e)=e

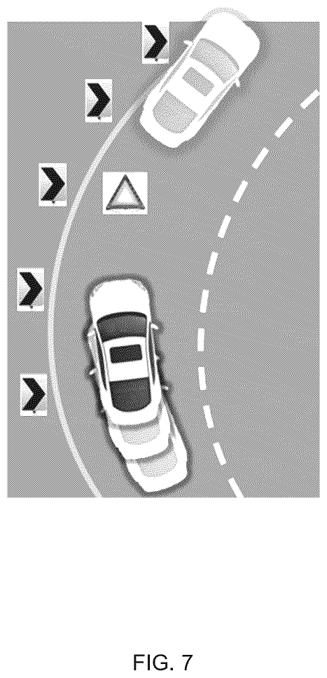

According to an embodiment of the present disclosure, FIG. 7 illustrates a case in which the host vehicle 100, under the control of the processor 110, is in a situation of requiring actual control, in a nighttime situation, in a high-curvature situation, and in a situation in which the target object is within the lane. Although the warnings are desensitized, normal control remains functional.

Here, the first index value V1 may be 1, the second index value V2 may be 0, the third index value V3 may be 1, the fourth index value L1 may be 1, the fifth index value L2 may be 0, and the sixth index value E may be 1. When the above values are applied to Equations 3 to 5 under the control of the processor 110, the equation may be expressed as follows.

Warning desensitization rate=1−{(1−a)*(1−c)*(1−d)*(1−f)}

Partial braking desensitization rate=1−(1−a)=a

Full braking desensitization rate=1−(1−0)=0

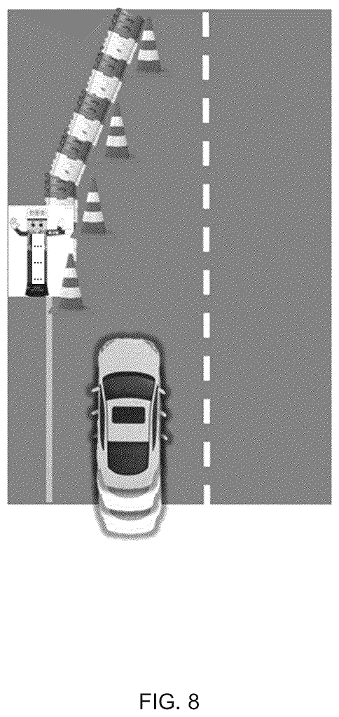

According to an embodiment of the present disclosure, FIG. 8 illustrates a case in which the host vehicle 100, under the control of the processor 110, is in a situation of requiring normal control, in a nighttime situation, in a straight-driving situation, and in a situation in which the target object is within the lane. In other words, some warnings are desensitized due to the nighttime determination, but normal braking control remains functional.

Here, the first index value V1 may be 0, the second index value V2 may be 0, the third index value V3 may be 0, the fourth index value L1 may be 0, the fifth index value L2 may be 0, and the sixth index value E may be 1. When the above values are applied to Equations 3 to 5 under the control of the processor 110, the equation may be expressed as follows.

Warning desensitization rate=1−(1−f)=f

Partial braking desensitization rate=1−(1−0)=0

Full braking desensitization rate=1−(1−0)=0

As described above, the host vehicle 100 according to embodiments of the present disclosure, under the control of the processor 110, may prevent sensitive warnings and sensitive control by managing the control sensitivity for general stationary obstacles while driving on the high-curvature road.

The host vehicle 100 according to embodiments of the present disclosure, under the control of the processor 110, may easily control sensitivity in various situations, such as when transitioning from a straight road to a curved road or from a curved road to a straight road.

The host vehicle 100 according to embodiments of the present disclosure, under the control of the processor 110, may control sensitivity not only based on the current driving behavior of the vehicle 100 but also by predicting future driving conditions.

The host vehicle 100 according to embodiments of the present disclosure, under the control of the processor 110, may strongly manage sensitivity control by determining the position of the control target within or outside the lane based on the lane curvature and control target position.

The host vehicle 100 according to embodiments of the present disclosure, under the control of the processor 110, may prevent unnecessary sensitive warnings during nighttime situations, in which lane accuracy decreases, by adjusting the sensitivity of warnings.

The autonomous driving vehicle and the control method thereof according to the embodiments of the present disclosure, configured as described above, may prevent unnecessary sensitivity warnings by controlling sensitivity based on the vehicle's behavior and environmental factors in high-curvature driving road conditions.

Also, the autonomous driving vehicle and the control method thereof according to the embodiments of the present disclosure may improve the driving stability of the autonomous driving vehicle by preventing unnecessary sensitivity warnings through sensitivity control in consideration of the behavior of the vehicle and environmental factors in high-curvature driving road conditions.

The effects achievable by the present disclosure are not limited to the effects mentioned above, and other effects not explicitly stated may be clearly understood by those having ordinary skill in the art to which the disclosure pertains from the following descriptions.

The above-described present disclosure may be implemented as a computer-readable code on a computer-readable medium in which a program is stored. The computer readable recording medium includes all types of recording devices in which data readable by a computer system is stored. Examples of the computer-readable recording medium include hard disk drives (HDD), solid state disks (SSD), silicon disk drives (SDD), read only memories (ROMs), random access memories (RAMs), compact disc read only memories (CD-ROMs), magnetic tapes, floppy discs, and optical data storage devices.

Thus, the detailed description is intended to be illustrative and not intended to limit the scope of the present disclosure in all aspects. It is intended that the scope of the present disclosure should be determined by the rational interpretation of the claims as set forth, and the modifications and variations of the present disclosure fall within the scope of the appended claims and their equivalents.

What is claimed is:

1. A vehicle comprising:
a processor configured to execute computer-readable instructions; and
a memory configured to store the computer-readable instructions,
wherein the processor is configured, by executing the computer-readable instructions, to:
receive sensor information from at least one of a plurality of sensors mounted to the vehicle;
recognize a target object in front of the vehicle based on the received sensor information;
determine a desensitization control point based on the target object and a driving environment condition of a current driving road of the vehicle; and
control braking of the vehicle based on the desensitization control point.

2. The vehicle of claim 1, wherein the driving environment condition comprises a first driving environment condition associated with a driving state of the vehicle traveling on a curved road, and
wherein the driving state is determined based on information of the vehicle sensed by at least one sensor of the plurality of sensors.

3. The vehicle of claim 2, wherein the processor is further configured, by executing the computer-readable instructions, to:
determine at least one index of a first index value (V1), a second index value (V2), or a third index value (V3) according to the first driving environment condition, and
determine the desensitization control point based on the at least one index.

4. The vehicle of claim 3, wherein the processor is further configured, by executing the computer-readable instructions, to determine a first predetermined value as the first index value (V1) based on a variation rate of a steering angle of the vehicle being deviated from a predetermined turning range.

5. The vehicle of claim 3, wherein the processor is further configured, by executing the computer-readable instructions, to determine a second predetermined value as the second index value (V2) based on a radius of a traveling path of the vehicle being within a predetermined high-curvature turning range.

6. The vehicle of claim 3, wherein the processor is further configured, by executing the computer-readable instructions, to determine a third predetermined value as the third index value (V3) based on an expected position of the vehicle after a predetermined time is within a predetermined rage.

7. The vehicle of claim 1, wherein the driving environment condition comprises a second driving environment condition associated with a position of the target object on a curved road based on lane information of the current driving road.

8. The vehicle of claim 7, wherein the processor is further configured, by executing the computer-readable instructions, to:
determine at least one index of a fourth index value (L1) or a fifth index value (L2) according to the second driving environment condition; and
determine the desensitization control point based on the at least one index.

9. The vehicle of claim 8, wherein the processor is further configured, by executing the computer-readable instructions, to determine a fourth predetermined value as the fourth index value (L1) based on a longitudinal position (Xm) of the target object with respect to the vehicle is within a predetermined range.

10. The vehicle of claim 8, wherein the processor is further configured, by executing the computer-readable instructions, to determine a fifth predetermined value as the fifth index value (L2) based on a transverse position of the target object is deviated from a lane of the vehicle.

11. The vehicle of claim 1, wherein the driving environment condition comprises a third driving environment condition associated with illumination environment information.

12. The vehicle of claim 11, wherein the processor is further configured, by executing the computer-readable instructions, to determine a sixth predetermined value as a sixth index value (E) based on the third driving environment condition being determined as nighttime.

13. A method for controlling a vehicle, the method comprising:
receiving, by a processor, sensor information from at least one of a plurality of sensors mounted to the vehicle;
recognizing, by the processor, a target object in front of the vehicle based on the received sensor information;
determining, by the processor, a desensitization control point based on the target object and a driving environment condition of a current driving road of the vehicle; and
controlling, by the processor, a braking of the vehicle based on the desensitization control point.

14. The method of claim 13, wherein the driving environment condition comprises a first driving environment condition associated with a driving state of the vehicle traveling on a curved road, and
wherein the driving state is determined based on information of the vehicle sensed by at least one sensor of the plurality of sensors.

15. The method of claim 13, wherein the driving environment condition comprises a second driving environment condition associated with a position of the target object on a curved road based on lane information of the current driving road.

16. The method of claim 13, wherein the driving environment condition comprises a third driving environment condition associated with illumination environment information.

17. The method of claim 14, wherein determining the desensitization control point comprises:
determining at least one index of a first index value (V1), a second index value (V2), or a third index value (V3) according to the first driving environment condition; and
determining the desensitization control point based on the at least one index.

18. The method of claim 17, wherein determining the at least one index of the first index value (V1), the second index value (V2), or the third index value (V3) comprises determining a first predetermined value as the first index value (V1) based on a variation rate of a steering angle of the vehicle being deviated from a predetermined turning range.

19. The method of claim 17, wherein determining the at least one index of the first index value (V1), the second index value (V2), or the third index value (V3) comprises determining a second predetermined value as the second index value (V2) based on a radius of a traveling path of the vehicle being within a predetermined high-curvature turning range.

20. The method of claim 17, wherein determining the at least one index of the first index value (V1), the second index value (V2), or the third index value (V3) comprises determining a third predetermined value as the third index value (V3) based on an expected position of the vehicle after a predetermined time is within a predetermined rage.
